(19) United States
(12) Patent Application Publication
(10) Pub. No.: US 2026/0285759 A1
(43) Pub. Date: Sep. 24, 2026

(54) METHOD FOR IMPROVING WORKABILITY OF INORGANIC BINDER COMPOSITION, AND INORGANIC BINDER COMPOSITION

(71) Applicant: SIKA TECHNOLOGY AG, Baar (CH)

(72) Inventors: Kenta ODA, Chigasaki (JP); Kaname SAITOH, Yokohama (JP); Atsushi TAMURA, Hiratsuka-shi (JP); Noriyuki ONODA, Hiratsuka-shi (JP)

(73) Assignee: SIKA TECHNOLOGY AG, Baar (CH)

(21) Appl. No.: 19/474,255

(22) PCT Filed: Jul. 8, 2024
(86) PCT No.: PCT/EP2024/069149

§ 371 Date: Oct. 10, 2025

(30) Foreign Application Priority Data
Jul. 7, 2023 (JP) 2023-112609

(51) Int. Cl. C04B 24/32; C04B 28/08; C04B 103/40

(52) U.S. Cl. CPC C04B 24/32; C04B 28/082; C04B 2103/408

(57) ABSTRACT

A method for improving the workability of an inorganic binder composition, and an inorganic binder composition. The method for improving the workability of an inorganic binder composition comprises: (a) providing a dispersant; (b) providing an inorganic binder composition; and (c) intermilling and/or intermixing the dispersant provided in step (a) and the inorganic binder composition provided in step (b), wherein the dispersant is a phenolic resin-based dispersant that is obtained via polycondensation of specific monomers.

### TECHNICAL FIELD

The present invention relates to a method for improving the workability of an inorganic binder composition, and to an inorganic binder composition.

### BACKGROUND ART

Recently, industrial byproducts (slag or fly ash) have been pro-actively used as inorganic binders in order to make more efficient use of resources or to mitigate the impact on the environment.

However, the use of slag or fly ash as at least part of the inorganic binder has sometimes compromised the workability or fluidity of the resulting inorganic binder composition.

The use of admixtures such as AE agents and water-reducing agents are known to enhance the workability of inorganic binder compositions like concrete compositions.

Polycarboxylic acid-based polymers are widely known as such admixtures, and the recent use of phenolic resin dispersants obtained via polycondensation of a plurality of phenolic co-monomers and aldehydes is also known.

In this regard, Patent Document 1, for example, proposes an admixture comprising a polycarboxylic acid-based polymer and a phenolic resin-based dispersant that is obtained via polycondensation of a plurality of phenolic co-monomers and aldehydes. According to Patent Document 1, this sort of admixture curbs the dark discolouration that is caused by the segregation of coloured fine particles (included in hydraulic compositions) on the surface of the cured product, also curbs slow setting, bleeding, and lower initial strength, despite containing an abundance of inorganic powder, and has better water-reducing performance.

### PRIOR ART DOCUMENTS

### Patent Documents

Patent Document 1: WO 2018/147378 A1

### SUMMARY OF THE INVENTION

### Problems to be Solved by the Invention

As noted above, the use of slag as an inorganic binder has sometimes compromised the workability of the resulting inorganic binder composition, particularly when a relatively high proportion of slag is used as the inorganic binder.

An object of the present invention is thus to provide a method for overcoming such problems, as well as an inorganic binder composition.

### Means for Solving the Problems

As a result of extensive research, the inventors perfected the present invention below upon discovering that the above problems can be solved by means of a specific phenolic resin-based dispersant that is obtained via polycondensation of a plurality of phenolic co-monomers and aldehydes.

### Embodiment 1

A method for improving the workability of an inorganic binder composition that contains a slag-containing inorganic binder, comprising the following steps (a) to (c):
(a) providing a dispersant;
(b) providing the inorganic binder composition; and
(c) intermilling and/or intermixing the dispersant provided in step (a) and the inorganic binder composition provided in step (b),
wherein the dispersant is a phenolic resin-based dispersant that is obtained via polycondensation of the following monomers (i) to (v):
(i) a mol % of a monomer represented by formula (I):

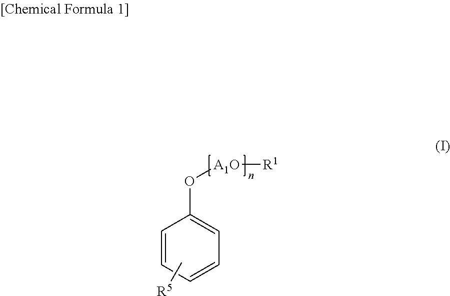

(ii) b mol % of a monomer represented by formula (II):

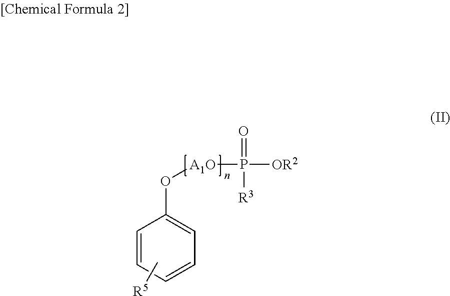

(iii) c mol % of a monomer represented by formula (III):

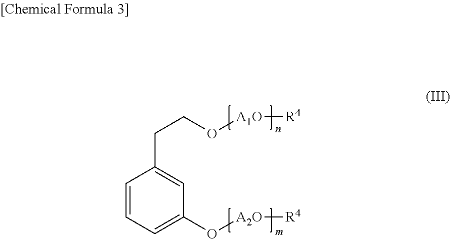

(iv) d mol % of a monomer represented by formula (IV):

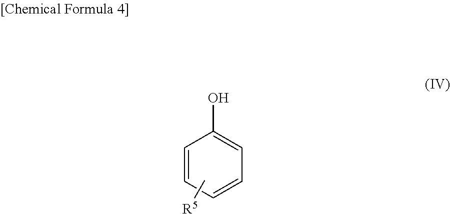

(v) e mol % of an aldehyde, preferably formaldehyde, meta-formaldehyde, para-formaldehyde, or formalin, or a mixture thereof, where
R¹ is H or a C₁₋₄ alkyl group or a C₂₋₅ acyl group,
R² is H, an alkali metal ion, an alkaline earth metal ion, or a moiety having the following structure:

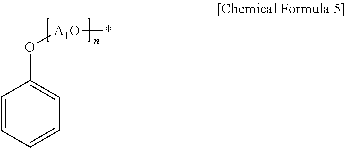

R³ is H or O—R²,
R⁴ is H, a C₁₋₄ alkyl group, or a phosphoric acid ester group,
R⁵ is H, a C₁₋₁₈ alkyl group, polyisobutene, or a sulfonic acid moiety,
A₁ and A₂ are each independently a CₓH₂ₓ group, where x=2 to 5,
n=1 to 350, m=2 to 300,
the a:b:c:d molar ratio is 0.1 to 2.0:0.1 to 6.0:0.1 to 2.0:0.0 to 0.5, and
the (a+b+c+d):e molar ratio is 1:10 to 10:1.

### Embodiment 2

The method according to Embodiment 1, wherein the slag content is at least 70% by mass, preferably at least 80% by mass, and in particular at least 85% by mass, relative to the total dry mass of the inorganic binder.

### Embodiment 3

The method according to Embodiment 1 or 2, wherein the slag is steel slag, preferably ground granulated blast-furnace slag, and in particular ground granulated blast furnace slag per the JIS A 6206:2013 standard.

### Embodiment 4

The method according to any of Embodiments 1 to 3, wherein the phenolic resin-based dispersant is intermilled and/or intermixed in an amount of 0.1 to 5% by mass, and preferably 0.5 to 1% by mass, relative to the total dry mass of the inorganic binder in step (c).

### Embodiment 5

The method according to any of Embodiments 1 to 4, wherein the dispersant is intermilled with the inorganic binder composition in a ball mill or a vertical roll mill in step (c).

### Embodiment 6

The method according to any of Embodiments 1 to 5, wherein the inorganic binder composition further comprises at least one polycarboxylic acid-based polymer and/or gluconate.

### Embodiment 7

An inorganic binder composition, comprising the following:
(a) 280 to 550 kg/m³ of slag-containing inorganic binder;
(b) 700 to 950 kg/m³ of fine aggregate, preferably sand,
(c) 800 to 1100 kg/m³ of coarse aggregate, preferably gravel, and
(d) 0.1 to 5% by mass, and preferably 0.5 to 1% by mass, of at least one dispersant, relative to the total dry mass of the inorganic binder;
said inorganic binder composition characterized in that the dispersant is a phenolic resin-based dispersant that is obtained via polycondensation of the above monomers (i) to (v).

### Embodiment 8

The inorganic binder composition according to Embodiment 7, wherein the inorganic binder is substantially composed of cement and slag.

### Embodiment 9

The inorganic binder composition according to Embodiment 7, wherein said inorganic binder composition furthermore comprises fly ash and/or fine calcium carbonate in addition to the cement and slag.

### Embodiment 10

The inorganic binder composition according to Embodiment 8 or 9, wherein the slag-to-cement mass ratio is 2.3:1 to 6:1, and preferably 3:1 to 5:1.

### Embodiment 11

The inorganic binder composition according to any of Embodiments 7 to 10, wherein the slag is steel slag, preferably ground granulated blast-furnace slag, and in particular ground granulated blast furnace slag per the JIS A 6206:2013 standard.

### Embodiment 12

The inorganic binder composition according to any of Embodiments 7 to 11, wherein the V funnel flow time per JSCE-F 512:1999 is no more than 10 seconds, as determined 5 minutes after being mixed with water at a water-to-inorganic binder mass ratio of 0.25 to 0.6.

### Embodiment 13

The inorganic binder composition according to any of Embodiments 7 to 12, further comprising at least one polycarboxylic acid-based polymer and/or gluconate.

### Embodiment 14

A moulded article, obtained by mixing the inorganic binder composition according to any of Embodiments 7 to 13 with water in a water-to-inorganic binder mass ratio of 0.25 to 0.6, and then curing the resulting mixture. 25

### Advantage of the Invention

The method and inorganic binder composition of the present invention make it possible to enhance the workability of an inorganic binder composition that is obtained when slag is used as the inorganic binder, particularly when a relatively high proportion of slag is used as the inorganic binder.

### MODES FOR CARRYING OUT THE INVENTION

<<Method for Improving the Workability of an Inorganic Binder Composition that Contains a Slag-Containing Inorganic Binder>>

The method of the present invention for improving the workability of an inorganic binder composition that contains a slag-containing inorganic binder comprises the following steps (a) to (c):
(a) providing a dispersant;
(b) providing an inorganic binder composition; and
(c) intermilling and/or intermixing the dispersant provided in step (a) and the inorganic binder composition provided in step (b).

The dispersant here is a phenolic resin-based dispersant that is obtained via polycondensation of the following monomers (i) to (v).

The method of present invention makes it possible to enhance the workability, and in particular to curb changes over time in slump and slump-flow, of an inorganic binder composition that is obtained when slag is used as an inorganic binder, particularly when a relatively high proportion of slag is used as the inorganic binder.

In the method of the present invention, the proportion of slag in the slag-containing inorganic binder may be 30% by mass or more, 40% by mass or more, 50% by mass or more, 60% by mass or more, 70% by mass or more, 80% by mass or more, 85% by mass or more, 90% by mass or more, or 95% by mass or more, and may be less than 100% by mass, 95% by mass or less, or 80% by mass or less. Examples of inorganic binders other than slag include cement, particularly portland cement. The inorganic binder may be substantially composed of cement and slag. The inorganic binder composition can furthermore include fly ash and/or fine calcium carbonate in addition to the cement and slag. The slag-to-cement mass ratio may be 2.3:1 to 6:1, and preferably 3:1 to 5:1.

The slag is steel slag, preferably ground granulated blast-furnace slag, and in particular ground granulated blast furnace slag per the JIS A 6206:2013 standard.

The phenolic resin-based dispersant can be intermilled and/or intermixed in an amount of 0.1 to 5% by mass, and preferably 0.5 to 1% by mass, relative to the total dry mass of the inorganic binder in step (c).

The dispersant can be intermilled with the inorganic binder composition in a ball mill or a vertical roll mill in step (c).

The inorganic binder composition in which the workability is improved by the method of the present invention may have a V funnel flow time per JSCE-F 512:1999 of no more than 10 seconds, as determined 5 minutes after being mixed with water at a water-to-inorganic binder mass ratio of 0.25 to 0.6.

The phenolic resin-based dispersant can be used in an amount within the range of 0.1 to 10% by mass, or 0.1 to 5% by mass, as calculated on the basis of solids, relative to the total mass of the inorganic binder.

The inorganic binder composition in which the workability is improved by the method of the present invention can be made into a moulded article by, for example, mixing the inorganic binder composition and water in a water-to-inorganic binder mass ratio of 0.25 to 0.6, and then curing the resulting mixture.

The inorganic binder composition obtained by the method of the present invention can furthermore comprise an aggregate to thereby form a concrete composition. Examples of aggregates include fine aggregates and coarse aggregates. Mountain sand, land sand, river sand, and fine sand are preferred as the fine aggregate, and mountain gravel, land gravel, river gravel, crushed stone, and hard sandstone are preferred as the coarse aggregate. Lightweight aggregate can also be used in some applications.

For example, the inorganic binder composition in which the workability is improved by the method of the present invention can comprise the following:
(a) 280 to 550 kg/m³ of slag-containing inorganic binder;
(b) 700 to 950 kg/m³ of fine aggregate, preferably sand,
(c) 800 to 1100 kg/m³ of coarse aggregate, preferably gravel, and
(d) 0.1 to 5% by mass, and preferably 0.5 to 1% by mass, of at least one phenolic resin-based dispersant, relative to the total dry mass of the inorganic binder.

The inorganic binder composition can also comprise the following:
(a) 5 to 95% by mass, and preferably 5 to 60% by mass, of slag-containing inorganic binder;
(b) 5 to 85% by mass, and preferably 20 to 80% by mass, of at least one kind of aggregate,
(c) 0.1 to 10% by mass of another additive, as needed, and
(d) and water in a water-to-solids mass ratio of 0.1 to 0.6, preferably 0.2 to 0.5, and in particular 0.2 to 0.35, as needed.

Monomers (i) to (v) for obtaining the phenolic resin-based dispersant via polycondensation are described in detail below.

<Monomer (i)>

Monomer (i) is represented by formula (I):

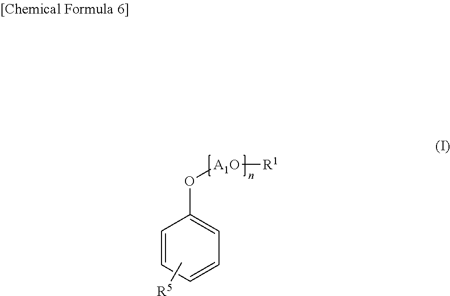

In formula (I),
R¹ is H or a C₁₋₄ alkyl group or a C₂₋₅ acyl group,
R⁵ is H, a C₁₋₁₈ alkyl group, polyisobutene, or a sulfonic acid moiety,
A₁ is a CₓH₂ₓ group, where x=2 to 5, and
n=1 to 350.

Monomer (i) is a compound in which a C₂₋₄ alkylene oxide has been added to a phenol or a substituent thereof, and also includes derivatives (alkyl esters or fatty acid esters) of said alkylene oxide adducts.

Examples of the C₁₋₄ alkyl group represented by R¹ include methyl, ethyl, propyl, and butyl groups, which may have a branched structure (such as isopropyl, isobutyl, sec-butyl, and tert-butyl groups) and/or a cyclic structure (such as cyclopropyl and cyclobutyl groups).

Examples of the C₁₋₅ acyl group represented by R¹ include saturated or unsaturated acyl groups (R′(CO)— groups, where R′ is a C₁₋₄ hydrocarbon group). Examples of C₂₋₄ saturated acyl groups include acetic acid, propionic acid, butanoic acid, and pentanoic acid.

Examples of C₁₋₁₈ alkyl groups represented by R⁵ include methyl, ethyl, propyl, butyl, pentyl, hexyl, heptyl, octyl, nonyl, decyl, dodecyl group (lauryl), tetradecyl (myristyl), hexadecyl (palmityl), and octadecyl (stearyl) groups, which may have a branched structure (such as isopropyl, isobutyl, sec-butyl, and tert-butyl, and neopentyl groups) and/or a cyclic structure (such as cyclopropyl, cyclopentyl, cyclohexyl, and 1-adamantyl groups).

Alkylene oxides (-A₁O—) have an alkylene group (CₓH₂ₓ group, where x=2 to 5). The alkylene oxide may therefore be ethylene oxide, propylene oxide, butylene oxide, or pentene oxide, which may be added alone or in combination. When two or more kinds of alkylene oxides combined are added, they may be added in blocks or randomly.

In one embodiment, at least some of the alkylene groups (CₓH₂ₓ groups) of the alkylene oxide (-A₁O—), such as 20 mol % or more, 25 mol % or more, or 30 mol % or more, have 3 to 5 carbon atoms (x=3 to 5). The proportion may be less than 100 mol %, 90 mol % or less, 80 mol % or less, 70 mol % or less, 60 mol % or less, 50 mol % or less, or 40 mol % or less. When at least some of the alkylene groups (CₓH₂ₓ groups) thus have 3 to 5 carbon atoms, the resulting phenolic resin-based dispersant can be made relatively hydrophobic, thus making it possible to furthermore enhance the workability, and in particular to curb changes over time in slump and slump-flow, of an inorganic binder composition that is obtained when slag is used as an inorganic binder, particularly when a relatively high proportion of slag is used as the inorganic binder.

In another embodiment, the alkylene groups (CₓH₂ₓ groups) of the alkylene oxide (-A₁O—) may all have 2 carbon atoms (x=2), specifically, they may all be ethylene.

The symbol n is the average number of mols of alkylene oxide added, and represents a number of 1 to 350, 1 to 300, or 1 to 150. Here, n may be 3 or more.

Monomer (i) can be used alone or in combinations of two or more.

<Monomer (ii)>

Monomer (ii) is represented by formula (II) below:

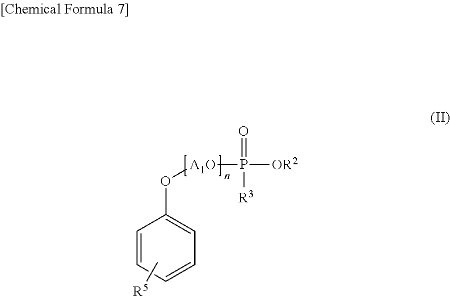

In formula (II),
R² is H, an alkali metal ion, an alkaline earth metal ion, or a moiety having the following structure:

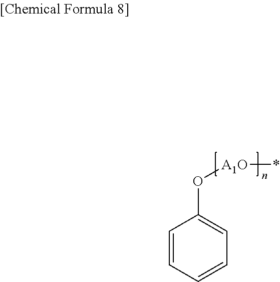

R³ is H or O—R²,
R⁵ is H, a C₁₋₁₈ alkyl group, polyisobutene, or a sulfonic acid moiety,
A₁ and A₂ are each independently a CₓH₂ₓ group, where x=2 to 5, and
n=1 to 350.

Monomer (ii) is a phosphate ester derivative of a compound in which a C₂₋₄ alkylene oxide has been added to phenol or substituent thereof.

Examples of alkali metal ions represented by R² can include sodium and potassium, and examples of alkaline earth metal ions represented by R² can include calcium and magnesium.

For R⁵, A₁, and n, see the description for monomer (i).

Monomer (ii) can be used alone or in combinations of two or more.

<Monomer (iii)>

Monomer (iii) is represented by formula (III) below:

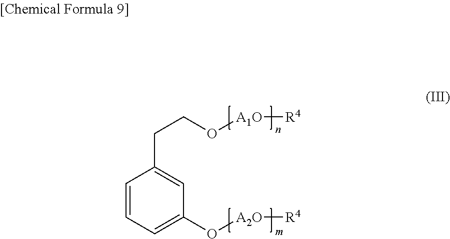

In formula (III),
R⁴ is H, a C₁₋₄ alkyl group, or a phosphoric acid ester group,
A₁ and A₂ are each independently a CₓH₂ₓ group, where x=2 to 5,
n=1 to 350, and m=2 to 300.

Monomer (iii) is a compound in which an alkylene oxide has been added to 2 hydroxy groups of hydroxyethyl phenol, and also includes derivatives (phosphate esters) of alkylene oxide adducts.

The hydroxyethyl phenol may be o-hydroxyethyl-phenol, m-hydroxyethyl-phenol, or p-hydroxyethyl-phenol. Monomer (iii) is preferably a compound (and ester derivative thereof) in which a C₂₋₅ alkylene oxide has been added to o-hydroxyethyl-phenol.

Anionizing the terminal of monomer (iii), specifically, producing a phosphate ester derivative, can shorten the mortar kneading time when added to a hydraulic composition.

For C₁₋₄ alkyl groups represented by R⁴, see the description of R1 for monomer (i). For A₁ and A₂, see the description of A₁ for monomer (i). For n, see the description of n₁ for monomer (i).

The symbol m is the average number of mols of alkylene oxide added, and represents a number of 2 to 300, 5 to 250, or 5 to 200.

Monomer (iii) can be used alone or in combinations of two or more.

<Monomer (iv)>

Monomer (iv) is represented by formula (IV) below:

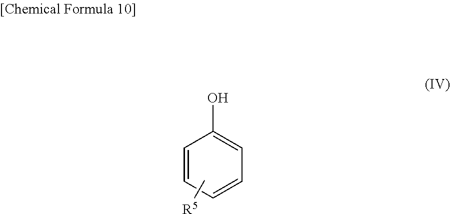

In formula (IV),
R⁵ is H, a C₁₋₁₈ alkyl group, polyisobutene, or a sulfonic acid moiety.

For R⁵, see the description for monomer (i).

<Monomer (v)>

Monomer (v) is an aldehyde, preferably formaldehyde, meta-formaldehyde, para-formaldehyde, or formalin, or a mixture thereof.

Monomer (v) can be used alone or in combinations of two or more.

### <Monomer Molar Ratio>

The molar ratio of monomers (i) to (iv), specifically, the a:b:c:d molar ratio, may be 0.1 to 2.0:0.1 to 6.0:0.1 to 2.0:0.0 to 0.5. Specifically, monomer (iv) is not an essential component, and can optionally not be used. The a:b:c:d molar ratio may be 0.5 to 1.5:0.5 to 6.0:0.1 to 1.0:0.0 to 0.5, 0.5 to 1.5:0.5 to 6.0:0.1 to 1:0.0, or 0.1 to 2.0:0.1 to 6.0:0.1 to 2.0:0.0.

The molar ratio of the total of monomers (i) to (iv) to monomer (v), specifically, the (a+b+c+d):e molar ratio, may be 1:10 to 10:1. The ratio may also be 2:10 to 10:2 or 3:10 to 10:3.

### <Polymerization Method for Obtaining Phenolic Resin-Based Dispersant>

The polymerization method for obtaining the above phenolic resin-based dispersant via polycondensation of the above monomers is not particularly limited.

The order and way in which the monomers are added during polycondensation are not particularly limited. For example, the entire amount of all the monomers that are going to be reacted can be added all at once prior to the polycondensation reaction; some of the monomers that are going to be used can be added, and the rest can then be added dropwise in batches, prior to the polycondensation reaction; or some of the monomers that are going to be used can be added before the polycondensation reaction, and the remaining monomers can be added after the reaction has taken place for a certain amount of time.

Polycondensates can be obtained, for example, via polycondensation of the monomers in the presence of a dehydration catalyst, with or without a solvent, at a reaction temperature of 80° C. to 150° C. and at ambient to increased pressure, such as 0.001 to 1 MPa (gauge pressure).

Examples of the dehydration catalyst include hydrochloric acid, perchloric acid, nitric acid, formic acid, methanesulfonic acid, octylsulfonic acid, dodecylsulfonic acid, vinylsulfonic acid, allylsulfonic acid, phenolsulfonic acid, acetic acid, sulfuric acid, diethyl sulfate, dimethyl sulfate, phosphoric acid, oxalic acid, boric acid, benzoic acid, phthalic acid, salicylic acid, pyruvic acid, maleic acid, malonic acid, nitrobenzoic acid, nitrosalicylic acid, para-toluenesulfonic acid, benzenesulfonic acid, dodecylbenzenesulfonic acid, trifluoromethanesulfonic acid, fluoroacetic acid, thioglycolic acid, mercaptopropionic acid, and activated clay, which can be used alone or in combinations of two or more.

Examples of solvents that can be used when the polycondensation reaction is carried out in the presence of a solvent include water, glycol ether compounds such as propylene glycol monomethyl ether (PGME), aromatic compounds such as toluene or xylene, and alicyclic compounds such as methylcyclohexane; any of the above dehydration catalysts (acid catalysts) that are suitable, such as acetic acid, can also be used as the solvent.

The polycondensation reaction can be carried at a reaction temperature of preferably 95° C. to 130° C., and the polycondensation reaction can be completed via reaction for 3 to 25 hours.

The polycondensation reaction is preferably carried out under acidic conditions, and the reaction system is preferably adjusted to a pH of 4 or less.

Other monomers that can be polycondensed with the above monomers may also be blended in addition to the monomers, provided that the effects of the present invention are not thereby compromised.

A variety of known methods can be used to lower the content of unreacted monomer (v) (such as an aldehyde) in the reaction system after the polycondensation reaction has been completed. Examples include: methods of heat treatment to between 6° and 140° C. at an alkaline reaction system pH; methods in which unreacted monomer (v) is volatilized off at a reduced reaction system pressure (by setting the gauge pressure to between −0.1 and −0.001 MPa, for example); and methods in which a small amount of sodium hydrogen sulfite, ethylene urea, and/or polyethyleneimine is furthermore added.

The dehydration catalyst used in the reaction can be neutralized and filtered off in the form of a salt after the reaction has been completed, but even if the catalyst is not removed, the performance of the dispersant of the present invention will not be impaired, as noted below. Examples methods for removing the catalyst include, in addition to the filtration noted above: phase separation, dialysis, ultrafiltration, and use of an ion exchanger.

The reaction product is also neutralized and diluted with water, for example, to enhance workability (such as metering) during use as a dispersant. Examples of basic compounds used for neutralization include alkali hydroxides such as sodium hydroxide and potassium hydroxide, alkaline earth metal hydroxides such as calcium hydroxide, and organic amines such as ammonia, monoethanolamine, diethanolamine, and triethanolamine; one or two of these may be used.

The phenolic resin-based dispersant that is ultimately obtained should have a weight-average molecular weight (as calculated on the basis of polyethylene glycol, by gel permeation chromatography (GPC)) in the range of 5,000 to 100,000, 10,000 to 80,000, or 15,000 to 35,000, to ensure better dispersion performance.

### <Additives>

In the method of the present invention for enhancing the workability of an inorganic binder composition containing a slag-containing inorganic binder, other additives such as polycarboxylic acid-based dispersants, and polycarboxylate ether-based dispersants in particular, can be used in combination with the phenolic resin-based dispersant of the present invention. When such other additives are intermilled and/or intermixed with the inorganic binder composition, the other additives can be intermilled and/or intermixed into the inorganic binder composition at the same time as, before, or after the phenolic resin-based dispersant of the present invention.

The ratio in which the phenolic resin-based dispersant of the present invention and the polycarboxylic acid-based dispersant are blended (phenolic resin-based dispersant:polycarboxylic acid-based dispersant (mass ratio)) may be 1:99 to 99:1, 1:9. to 3:1, or 1:5 to 1:1. When used in combination, the phenolic resin-based dispersant of the present invention and the polycarboxlyic acid-based dispersant can be used in the range of 0.1 to 10% by mass, or 0.1 to 5% by mass, as calculated on the basis of solids, relative to the total mass of the inorganic binder.

Examples of other additives that can be given include at least one other cement or concrete additive selected from the group consisting of cement dispersants, high-performance AE water-reducing agents, high-performance water-reducing agents, AE water-reducing agents, water-reducing agents, air-entrainment agents (AE agents), foaming agents, antifoaming agents, concrete retarders, setting accelerators, separation reducers, thickeners, shrinkage reducers, curing compounds, and water repellents. Examples of other additives that can be used in particular include retarders such as gluconate salts, particularly sodium gluconate.

For polycarboxylic acid-based dispersants that can be used in the present invention, see the description in Patent Document 1.

Specifically, the polycarboxylic acid-based polymer Q which can be used in the present invention has structural units that have an amino group and an imino group, and/or structural units that have an amino group, an imino group, and an amide group.

The polycarboxylic acid-based polymer Q functions as a dispersant for hydraulic compositions, and its use can be expected to afford concrete that has less slump loss.

The structural units that have an amino group and an imino group, and the structural units that have an amino group, an imino group, and an amide group in the polycarboxylic acid-based polymer Q are derived from compounds that have an amino group and an imino group, and compounds that have an amino group, an imino group, and an amide group, respectively.

Compounds that have an amino group and an imino group, and compounds that have an amino group, an imino group, and an amide group are compounds that have at least 1 mol each of an amino group (a primary amine) and an imino group (a secondary amine) in the unit structure, and in some cases also an amide group formed by the condensation of a carboxylic acid with the amino group or imino group (not mandatory) per mol of unit structure.

The above compounds may be either low-molecular or high-molecular weight compounds. Examples of low-molecular weight compounds include compounds having an amino group and an imino group, and/or compounds having an amino group, an imino group, and an amide group, which are derived, for example, from: aliphatic, alicyclic, or aromatic amines, such as ethylamine, ethyleneamine, diethylamine, or aniline; heterocyclic amines, such as 1-benzofuran-2-ylamine or 4-quinolylamine; aliphatic imines, such as hexylideneamine or isopropylideneamine; or hydroxylamines or acid amides (other than aliphatic, alicyclic, or aromatic amides), such as acetamide, benzamide, or a lactam; as well as adducts, obtained via the addition of, for example, oxygen- or nitrogen-containing functional groups such as alkylene oxides, or halogen-containing (fluorine, bromine, iodine) substituents, to the above compounds. Examples of high-molecular weight compounds include: compounds that can be derived from the above low-molecular weight compounds by polymerizing one or more of the compounds given as examples; as well as polyalkylene polyamines, and polyamide polyamines.

The molecular weight of the above compounds is 900 to 10,000, preferably 900 to 3,000, and more preferably 900 to 2,000. Specific examples of the above compounds in this case are polyalkylene polyamines or polyamide polyamines, which may include alkylene oxide adducts thereof.

Specifically, in a preferred embodiment, the structural units having an amino group and an imino group are preferably derived from polyalkylene polyamines, where such polyalkylene polyamines can include polyalkylene oxide adducts of polyalkylene polyamines.

The structural units having an amino group, an imino group, and an amide group are also preferably derived from polyamide polyamines, where such polyamide polyamines can include polyalkylene oxide adducts of polyalkylene polyamines.

Examples of polyalkylene polyamines include ethylenediamine, diethylenetriamine, triethylenetetramine, tetraethylenepentamine, pentaethylenehexamine, hexaethyleneheptamine, or mixtures of high-molecular weight polyethylene polyamines that are mixtures containing an abundance of ethylene units and nitrogen atoms; cyclic polyethyleneimine, polypropyleneimine, poly-3-imine polymers, such as methylpropylimine, and poly-2-ethylpropylimine; and unsaturated amine polymers, such as polyvinylamine and polyallylamine. Polyalkylene polyamines may also be copolymers of cyclic imines (such as ethyleneimine, propyleneimine, 3-methylpropylimine, and 2-ethylpropylimine), unsaturated amides (such as N-vinylacetamide, N-vinylformamide, and

N-vinylphthalimide), or unsaturated imides with unsaturated compounds that are copolymerizable with the above. Examples of unsaturated compound that can be copolymerized with cyclic imines, unsaturated amides, or unsaturated imides, for example, include dimethylacrylamide, styrene, methyl acrylate, methyl methacrylate, acrylic acid, methacrylic acid, styrenesulfonic acid, and salts thereof; cyclic sulfide compounds, such as ethylene sulfide and propylene sulfide; cyclic ethers, such as oxetane, mono- or bis-alkyl oxetane, mono- or bis-alkyl chloromethyloxetane, tetrahydrofuran, and mono- or bis-alkyl tetrafluorofuran; cyclic formals, such as 1,2-dioxofuran and trioxofuran; and N-substituted alkylimines, such as N-methylethyleneimine.

Polyalkylene oxide adducts of polyalkylene polyamines are compounds that are obtained via copolymerization of at least two molecules of a polyalkylene polyamine noted above and at least one molecule of an alkylene oxide. The at least two molecules of a polyalkylene polyamine constituting the polyalkylene polyamine-alkylene oxide copolymer may be the same or different compounds. Examples of alkylene oxides include ethylene oxide, propylene oxide, and butylene oxide, which can be used in combination. The alkylene oxide is preferably ethylene oxide in the interests of better water-reducing effects. When two or more molecules of an alkylene oxide are copolymerized per two molecules of a polyalkylene polyamine in the polyalkylene polyamine-alkylene oxide copolymer, a polyoxyalkylene chain in which the alkylene oxides are addition polymerized together may be formed. One kind of alkylene oxide may be used, or 2 or more kinds may be used; when the polyoxyalkylene chain is formed using two or more kinds of alkylene oxides, the 2 or more kinds of alkylene oxides constituting the polyoxyalkylene chain may be bonded in blocks or randomly. When two or more polyoxyalkylene chains are present per polyalkylene polyamine copolymer molecule, the polyoxyalkylene chains may be the same as or different from each another.

Examples of polyamide polyamines include compounds through the polycondensation of a polyalkylene polyamine noted above with a dibasic acid, dibasic acid anhydride, dibasic acid ester, or dibasic acid dihalide, for example, via amide bonds. Examples of dibasic acids include C₂₋₁₀ aliphatic saturated dibasic acids, such as oxalic acid, malonic acid, succinic acid, glutaric acid, adipic acid, pimelic acid, suberic acid, azelaic acid, and sebacic acid; and examples of dibasic acid anhydrides include anhydrides of the dibasic acids noted above. Examples of dibasic acid esters include monomethyl esters, monoethyl esters, monobutyl esters, monopropyl esters, dimethyl esters, diethyl esters, dibutyl esters, and dipropyl esters of the dibasic acids noted above; and examples of dibasic acid dihalides include dichlorides, dibromides, and diiodides of the dibasic acids noted above.

Polyalkylene oxide adducts of polyamide polyamines are compounds obtained by the addition of an alkylene oxide to an amino group, an imino group, or an amide group per molecule of the polyamide polyamines noted above. Examples of alkylene oxides include ethylene oxide, propylene oxide, and butylene oxide, which can be used alone or in combination; when 2 or more kinds of alkylene oxides are used, they may be bonded in blocks or randomly.

Examples of polycarboxylic acid-based polymers Q that can preferably be used in the present invention include polymers that have: a copolymer unit obtained by copolymerization of a monomer mixture containing a monomer represented the following general formula (1) (“monomer E”) and a monomer represented by the following general formula (2) (“monomer F”); a structural unit having an amino group and an imino group as noted above; and/or a structural unit having an amino group, an imino group, and an amide group as noted above. This sort of polymer can be obtained by the copolymerization of monomer E represented by the following general formula (1) and monomer F represented by the following general formula (2) with a monomer having structural units having an amino group and an imino group as noted above or structural units having an amino group, an imino group, and an amide group as noted above (“monomer G”).

In monomer E represented by the following general formula (1), R¹¹, R¹², R¹³, and R¹⁴ each independently represent a hydrogen atom or a C₁₋₂₂ hydrocarbon group, X represents —COO—, —CON<, or —(CH₂)b-O—, and AO represents a C₂₋₄ alkylene oxide group. The symbol a represents the average number of mols in which the alkylene oxide is added, which is a number from 1 to 200, and preferably a number from 30 to 150. When X is —(CH₂)bO—, b represents a number from 1 to 20.

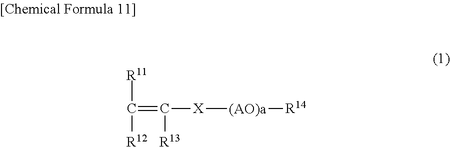

Monomer E represented by general formula (1) is more specifically a polyalkylene glycol-based monomer having polymerization activity, which is a monomer that has a polymerization active group and polyalkylene glycol as structural units, such as: alkenyl ethers formed from a C₃₋₈ alkenyl ether and an (alkoxy)alkylene glycol, such as a polyalkylene glycol monoallyl ether, alkylene glycol monoalkenyl ether, methoxypolyalkylene glycol monoallyl ether, and methoxyalkylene glycol monoalkenyl ether; alkoxyalkylene glycol (meth)acrylates formed from (meth)acrylic acid and a C₁₋₂₂ alkoxypolyalkylene glycol, such as a methoxypolyalkylene glycol, ethoxypolyalkylene glycol, or propoxypolyalkylene glycol; alkoxyalkylene glycol unsaturated fatty acid esters formed from a C₁₋₂₂ alkoxypolyalkylene glycol and an unsaturated fatty acid such as oleic acid; alkoxyalkylene glycol amide compounds formed from an α-alkoxy-ω-amino-polyalkylene glycol having a terminal amino group and (meth)acrylic acid or an unsaturated fatty acid; and unsaturated aliphatic ethers that are unsaturated aliphatic alcohol-alkylene oxide adducts. The structure of this polyalkylene glycol is formed from C₂₋₄ alkylene oxides, consisting of ethylene oxide, propylene oxide, and/or butylene oxide, added either alone or in combination; combined addition may be either random or block addition. These polyalkylene glycol-based monomers having polymerization activity can be used alone or in combination.

In monomer F represented by the following general formula (2), R¹⁵, R¹⁶, R¹⁷, and R¹⁸ each independently represent a hydrogen atom, a C₁₋₂₂ hydrocarbon group, —(CH2)c-COOM, —COOM, —COOR¹⁹ (where R¹⁹ represents a C₁₋₂₂ hydrocarbon group, —(CH2)c-COOM, —COOM, or a glycidyl group), or a glycidyl group, or R¹⁵ and R¹⁶, or R¹⁷ and R¹⁸ form an acid hydride together with the >C═C< group in formula (2). The symbol c represents a number from 1 to 20. M represents a hydrogen atom, an alkali metal, an alkaline earth metal, ammonium, or an alkanolamine.

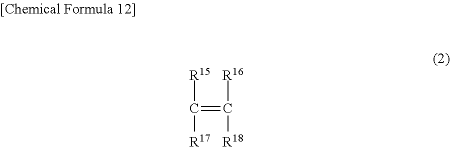

More specific examples of monomer F represented by general formula (2) above include unsaturated aliphatic acids and ester derivatives thereof, such as maleic acid, maleic anhydride, itaconic acid, methacrylic acid, acrylic acid, dialkyl maleate esters, alkyl methacrylate esters, and alkyl acrylate esters; and glycidyl compounds, such as glycidyl methacrylate, glycidyl acrylate, and glycidyl allyl ethers. These may be in the form of acids or in neutralized form, where sodium, potassium, calcium, magnesium, ammonium ions, and alkanolamines, for example, are used when neutralized. These acids or neutralized salts may be used alone or in combination.

Examples of monomer G having structural units that have an amino group and an imino group, or structural units that have an amino group, an imino group, and an amide group include condensates of compounds having an amino group and an imino group above, or compounds having an amino group, imino group, and amide group above, and acrylic acid, methacrylic acid, or esters formed from acrylic acid or methacrylic acid and a C1-4 lower alcohol; the method of production is specifically disclosed in, for example, Japanese Patent No. 3235002, Japanese Patent No. 3346456, Japanese Patent No. 3740641, and Japanese Patent No. 3780456.

In the interests of reducing slump loss, the monomer E, monomer F, and monomer G copolymerization ratio should be a mass ratio in the range of E:F:G=50 to 90:5 to 40:5 to 40 (where the total of the mass ratio of the three monomers E, F, and G is 100).

The method for producing the copolymer is not particularly limited, and known methods of polymerization such as solution polymerization or bulk polymerization using a polymerization initiator can be employed.

The polycarboxylic acid-based polymer Q of the present invention may be obtained by copolymerizing, in addition to the above monomers, other monomers that are copolymerizable with said monomers, provided that the effects of the invention are not thereby compromised. Examples include the following known copolymerizable monomer components: (non) aqueous monomers, such as styrene; anionic monomers, such as vinylsulfonic acid, styrenesulfonic acid, (meth)acrylic acid phosphate ester salts, and phosphate ester salts of (meth)acrylic acid-alkylene oxide adducts; amide-based monomers, such as acrylamide and acrylamide-alkylene oxide adducts; amine-based monomers, such as polyalkylene polyimine compounds; polyalkylene glycol-based monomers, such as mono- or di-esters of a polyalkylene glycol and maleic anhydride, and esters of a polyalkylene glycol and itaconic acid.

These additional monomers can be used in an amount of about 0 to 20% by mass relative to the total mass of monomer E represented by general formula (1), monomer F represented by general formula (2), monomer G, and the additional monomer(s).

Compounds having an amino group and an imino group above and/or compounds having an amino group, an imino group, and an amide group above are bonded to a polycarboxylic acid-based polymer Qo via grafting groups or cross linking groups to produce the structural units that have an amino group and an imino group and/or the structural units that have an amino group, an imino group, and an amide group in the polycarboxylic acid-based polymer Q of the present invention. The polycarboxylic acid-based polymer Qo here is not particularly limited, provided that it is a polycarboxylic acid-based polymer having functional groups that are graft-bondable or cross linkable with compounds having the above amino groups and imino groups, such as acid groups, acid anhydride groups, glycidyl groups, and acid ester groups, and/or compounds having amino group, imino groups, and amide groups. The polycarboxylic acid-based polymer Qo is prepared, for example, via copolymerization of the aforementioned monomer E, monomer F, and additional monomer(s) as needed, where specific examples of the polycarboxylic acid-based polymer Qo include: copolymers of maleic anhydride and a polyalkylene glycol monoalkenyl ether; copolymers of maleic anhydride and an allyl alcohol-alkylene oxide adduct monomethyl ether; copolymers of (meth)acrylic acid and an (alkoxy)polyalkylene glycol (meth)acrylate; copolymers of (meth)acrylic acid, glycidyl (meth)acrylate, and an (alkoxy)polyalkylene glycol (meth)acrylate; copolymers of (meth)acrylic acid, a monomer having a sulfone group, and an (alkoxy)polyalkylene glycol (meth)acrylate; copolymers of (meth)acrylic acid, a monomer having a phosphate group, and an (alkoxy)polyalkylene glycol (meth)acrylate; and copolymers of (meth)acrylic acid, a (meth)acrylate alkyl ester, and an (alkoxy)polyalkylene glycol (meth)acrylate.

The polycarboxylic acid-based copolymer Q used in the present invention should have a weight-average molecular weight in the range of 1,000 to 500,000 (as calculated on the basis of polyethylene glycol, by gel permeation chromatography); a molecular weight outside this range will significantly compromise the water-reducing performance or will fail to provide the desired effect in reducing slump loss.

In the present invention, the reaction solution containing the polycarboxylic acid-based copolymer Q produced as noted above, for example, may be used as such in admixtures for a hydraulic composition in the present invention as well as in combinations for preparing admixtures for a hydraulic composition in the present invention. In such cases, the solution can contain unreacted components and by-products (that are produced in, for example, the various polymerization steps, grafting steps, cross linking steps, and alkylene oxide addition steps) in addition to the polycarboxylic acid-based copolymer Q.

### <<Inorganic Binder Composition>>

The inorganic binder composition of the present invention comprises the following:
(a) 280 to 550 kg/m³ of slag-containing inorganic binder;
(b) 700 to 950 kg/m³ of fine aggregate, preferably sand,
(c) 800 to 1100 kg/m³ of coarse aggregate, preferably gravel, and
(d) 0.1 to 5% by mass, and preferably 0.5 to 1% by mass, of at least one dispersant, relative to the total dry mass of the inorganic binder.

The dispersant here is a phenolic resin-based dispersant that is obtained via polycondensation of the following monomers (i) to (v).

The inorganic binder composition of present invention makes it possible to enhance the workability, and in particular to curb changes over time in slump and slump-flow, of an inorganic binder composition that is obtained when slag is used as an inorganic binder, particularly when a relatively high proportion of slag is used as the inorganic binder.

For details such as on the features and embodiments of the use of the inorganic binder composition of the present invention, see the disclosures relating to the method of the present invention for enhancing the workability of inorganic binder compositions.

### <<Moulded Article>>

The moulded article of the present invention is obtained by mixing the inorganic binder composition of the present invention with water in a water-to-inorganic binder mass ratio of 0.25 to 0.6, and then curing the resulting mixture.

For details such as on the features of the moulded article of the present invention, see the disclosures relating to the method of the present invention for enhancing the workability of inorganic binder compositions.

### <<Moulded Article>>

The moulded article of the present invention is obtained by mixing the inorganic binder composition of the present invention with water in a water-to-inorganic binder mass ratio of 0.25 to 0.6, and then curing the resulting mixture.

For details such as on the features of the moulded article of the present invention, see the disclosures relating to the method of the present invention for enhancing the workability of inorganic binder compositions.

### <<Admixture and Phenolic Resin-Based Dispersant>>

The admixture of the present invention comprises the following or consists of the following (ratio of each to total mass of admixture):
(a) 20 to 80% by mass, preferably 50 to 80% by mass, more preferably 64 to 75% by mass of at least one dispersant;
(b) 10 to 45% by mass, preferably 15 to 40% by mass, more preferably 15 to 35% by mass of at least one polycarboxylic acid-based polymer;
(c) 1 to 20% by mass, and preferably 1 to 10% by mass of at least one retarder, preferably sodium gluconate;
(d) optional additional additives, and
(e) the remainder, water, in an amount bringing the total to 100% by mass.

The dispersant here is a phenolic resin-based dispersant that is obtained via polycondensation of the following monomers (i) to (v).

The phenolic resin-based dispersant of the present invention, specifically, the phenolic resin-based dispersant for improving the workability of an inorganic binder composition containing a slag-containing inorganic binder, is obtained via polycondensation of the above monomers (i) to (v).

The admixture and phenolic resin-based dispersant of the prevent invention can be combined with an inorganic binder to obtain an inorganic binder composition. The admixture and phenolic resin-based dispersant of the prevent invention make it possible to enhance the workability, and in particular to curb changes over time in slump and slump-flow, of an inorganic binder composition that is obtained when slag is used as an inorganic binder, particularly when a relatively high proportion of slag is used as the inorganic binder.

For details such as on the features and embodiments of the use of the admixture and phenolic resin-based dispersant of the present invention, see the disclosures relating to the method of the present invention for enhancing the workability of inorganic binder compositions.

When the phenolic resin-based dispersant of the present invention is used in combination with a polycarboxylic acid-based dispersant, the combination can be used as the admixture of the present invention (comprising the phenolic resin-based dispersant of the present invention and a polycarboxylic acid-based dispersant), and the phenolic resin-based dispersant of the present invention and the polycarboxylic acid-based dispersant can be added individually during the production of an inorganic binder composition, for example.

### Examples

The present invention is illustrated by the following examples. However, the present invention is not limited in any way by these examples. In the following examples, “parts” means “parts by mass.”

### <<Preparation of Phenolic Resin-Based Dispersant>>

### (Preparation of Monomer Represented by Formula (I))

80 parts of diethylene glycol monophenyl ether (Hisolve DPH, by Toho Chemical Industry Co., Ltd.) and 0.2 part of 96% potassium hydroxide were introduced into a stainless steel high-pressure reactor equipped with a thermometer, a stirrer, a pressure gauge, and a nitrogen-feed tube, the interior of the reactor was purged with nitrogen, and the contents were heated to 150° C. in the resulting nitrogen atmosphere. As the system was kept at a temperature of 150° C. and at a safe pressure, 1,700 parts of ethylene oxide were introduced into the reactor over a 10-hour period, and the temperature was then maintained for two hours, completing the alkylene oxide addition reaction and giving polyethylene glycol monophenyl ether (number of mols of EO added: 90) as the monomer represented by formula (I).

### (Preparation of Monomer Represented by Formula (II))

Starting material p-tert-butylphenol (PTBP, by DIC) was used to carry out an ethylene oxide addition reaction per the method for preparing the monomer represented by formula (I) to obtain an alkylene oxide adduct. Six mols of ethylene oxide were added.

3 mols of the p-tert-butylphenol-EO adduct (6-mol adduct) were introduced into a glass reactor equipped with a stirrer, a thermometer, and a nitrogen-feed tube, and 1 mol of phosphoric anhydride was introduced into the reactor over a 4-hour period at 50° C. with nitrogen bubbling to bring about a reaction. An aging reaction was then carried out for 3 hours at 100° C., and the phosphate ester reaction was completed giving a phosphate ester of the p-tert-butylphenol-EO adduct as the monomer represented by formula (I).

### (Preparation of Monomer Represented by Formula (III))

100 parts of ortho-hydroxyethylphenol (reagent by Aldrich) and 0.3 part of 96% potassium hydroxide were introduced into a stainless steel high-pressure reactor equipped with a thermometer, a stirrer, a pressure gauge, and a nitrogen-feed tube, the interior of the reactor was purged with nitrogen, and the contents were heated to 130° C. in the resulting nitrogen atmosphere. As the system was kept at temperature of 130° C. and at a safe pressure, 190 parts of ethylene oxide were introduced into the reactor over a 4-hour period, and the temperature was then maintained for two hours, completing the alkylene oxide addition reaction and giving an EO adduct (total of 6 mols) of ortho-hydroxyethylphenol as the monomer represented by formula (III).

### <<Preparation of Phenolic Resin-Based Dispersant A1>>

The raw materials of the monomers represented by formulas (I) to (III) above were introduced in the molar ratios shown in Table 1 into a glass reactor equipped with a stirrer, a thermometer, and a reflux condenser. The contents were heated to 70° C., and 98% sulfuric acid was then introduced in an amount of 1.0% by mass relative to the total mass of the monomers represented by formulas (I) to (III) above. Formalin (HCHO) as the monomer represented by formula (V) was then introduced all at once into the reactor in the molar ratio shown in Table 1, and the contents were then heated to 105° C. When the temperature reached 105° C., the pH of the reaction mixture was 2.1 (1% aqueous solution, 20° C.). The reaction was completed six hours after the temperature reached 105° C., 48% sodium hydroxide was introduced, and the reaction solution (in the form of a 1% aqueous solution) was neutralized to a pH in the range of 5.0 to 7.5. The reaction product was then adjusted to a solids concentration of 40% with the addition of a suitable amount of water, giving an aqueous solution of phenolic resin-based dispersant A1 in the form of a polycondensation product. The weight-average molecular weight Mw of the phenolic resin-based dispersant A1 was determined by gel permeation chromatography (GPC).

The conditions of permeation chromatography (GPC) in the present invention are given below:

Columns: OHpak SB-802.5HQ, OHpak SB-803HQ, and OHpak SB-804HQ (by Showa Denko K.K.)

Eluent: Mixture of 50 mM aqueous sodium nitrate solution and acetonitrile (volume ratio 80/20)

Detector: Differential refractometer; Calibration curve: polyethylene glycol

### <<Preparation of Phenolic Resin-Based Dispersants A2 to A5>>

Aqueous solutions of phenolic resin-based dispersants A2 to A5 were obtained in the form of polycondensation products in the same manner as in the preparation of phenolic resin-based dispersant A1, except that the types and molar ratios of the raw materials for the monomers of formulas (I) to (III) and (V) were changed as shown in Table 1.

### <<Preparation of Phenolic Resin-Based Dispersants B1 to B5>>

Aqueous solutions of phenolic resin-based dispersants B1 to B5 were obtained in the form of polycondensation products in the same manner as in the preparation of phenolic resin-based dispersant A1, except that the types and molar ratios of the raw materials for the monomers of formulas (I) to (III) and (V) were changed as shown in Table 1.

However, polyethylene glycol groups (CₓH₂ₓ groups, where x=2) were added using ethylene oxide (EO) as the alkylene oxide (AO) to synthesize the monomers of formulas (I) to (III) for phenolic resin-based dispersants A1 to A5, whereas a mixture of alkylene oxides was added as the alkylene oxide (AO) to synthesize the monomers of formulas (I) to (III) for phenolic resin-based dispersants B1 to B5. Table 1 shows the ratio of CₓH₂ₓ groups in which x was 3 to 5 (X=3 to 5 (mol %)) relative to the total of CₓH₂ₓ groups in which was 2 to 5.

TABLE 1

| | | | | | | | | | | AO | | | | | | |
|---|---|---|---|---|---|---|---|---|---|---|---|---|---|---|---|---|
| Phenolic | | | | | | | | | | Proportion | | | | | | |
| resin- | | | | Monomer (II) | | | | | | of x = | | | | | | |
| based | Monomer (I) | | | | R2, | | Monomer (III) | | | 3 to 5 | Monomer | Proportions (molar ratio) | | | | GPC |
| dispersant | R1 | R5 | n | R5 | R3 | n | m | n | R4 | (Mol %) | (V) | (I) | (II) | (III) | (V) | Mw |
| A1 | H | H | 90 | p-t-Bu | H | 6 | 3 | 3 | H | 0 | HCHO | 1.0 | 2.0 | 0.5 | 5.0 | 23,000 |
| A2 | H | H | 90 | p-t-Bu | H | 6 | 3 | 3 | H | 0 | HCHO | 1.0 | 1.0 | 0.5 | 5.0 | 28,000 |
| A3 | H | H | 90 | p-t-Bu | H | 6 | 3 | 3 | H | 0 | HCHO | 1.0 | 3.0 | 0.5 | 5.0 | 17,000 |
| A4 | H | H | 90 | p-t-Bu | H | 6 | — | — | — | 0 | HCHO | 1.0 | 2.0 | — | 5.0 | 21,000 |
| A5 | H | H | 90 | p-t-Bu | H | 6 | 3 | 3 | H | 0 | HCHO | 1.0 | 2.0 | 0.5 | 5.0 | 22,000 |
| B1 | H | H | 90 | p-t-Bu | H | 6 | 3 | 3 | H | 20 | HCHO | 1.0 | 1.0 | 0.5 | 5.0 | 28,000 |
| B2 | H | H | 90 | p-t-Bu | H | 6 | 3 | 3 | H | 30 | HCHO | 1.0 | 1.0 | 0.5 | 5.0 | 29,000 |
| B3 | H | H | 90 | p-t-Bu | H | 6 | 3 | 3 | H | 10 | HCHO | 1.0 | 1.0 | 0.5 | 5.0 | 27,000 |
| B4 | H | H | 90 | p-t-Bu | H | 6 | 3 | 3 | H | 30 | HCHO | 1.0 | 5.0 | 0.5 | 5.0 | 7,000 |
| B5 | H | H | 90 | p-t-Bu | H | 6 | 3 | 3 | H | 10 | HCHO | 1.0 | 5.0 | 0.5 | 5.0 | 5,000 |

### <<Preparation of Polycarboxylic Acid-Based Dispersant Q1>>

103 g (1.00 mol) of diethylenetriamine and 97.3 g (0.67 mol) of adipic acid were introduced into a stirred reactor, nitrogen was introduced, and the contents were stirred and mixed in the resulting nitrogen atmosphere. The contents were heated to 150° C. and were reacted for 20 hours to an acid value of 22 as the reaction product water associated with the polycondensation was removed. 1.1 g of hydroquinone methyl ether and 27.5 g (0.32 mol) of methacrylic acid were then introduced, and the contents were reacted over a 10-hour period at the same temperature (150° C.). This resulted in 187 g of polyamide polyamine (melting point: 122° C.; acid value: 23) along with 42 g (total) of water distilled off from the reaction.

All of the polyamide polyamine was dissolved in 272 g of water, and the solution was heated to a temperature of 50° C. At the same temperature (50° C.), 220 g of ethylene oxide (corresponding to 3.0 mol relative to the total amino residue containing unreacted amino group) was gradually introduced over a 4-hour period, and the contents were then aged for 2 hours. This resulted in 680 g of a polyamide polyamine-EO adduct (60% solids).

180 g of water was introduced into a stirred reactor, nitrogen was introduced to create a nitrogen atmosphere in the synthesis system, and the contents were heated to 80° C. The following were added dropwise into the synthesis system over a 3-hour period: a mixture of 150 g of water, 98.2 g of the above polyamide polyamine-EO adduct, 72.0 g of methacrylic acid, 60.9 g of short-chain methoxypolyethylene glycol monomethacrylate (short-chain MPEGM; molecular weight: 1,000), and 183 g of long-chain methoxypolyethylene glycol monomethacrylate (long-chain MPEGM; molecular weight: 2,000) (when the methacrylic acid was used in the form of a sodium salt, the proportions in which the components were added were calculated as polyamide polyamine-EO adduct: 15% by mass; methacrylic acid: 23% by mass; short-chain MPEGM: 15% by mass; and long-chain MPEGM: 47% by mass (total of 100% by mass)); and 66.4 g of a 5% aqueous thioglycolic acid solution; this was followed by the dropwise addition of 123 g of a 5% aqueous sodium persulfate solution over a 3-hour period. The contents were then aged over a 2-hour period, and were cooled. The product was then neutralized to a pH of 7 using a 48% aqueous NaOH solution, giving 1,029 g of a polycarboxylic acid-based dispersant Q1. The weight-average molecular weight Mw of the polycarboxylic acid-based dispersant Q1 was 46,000, as determined by GPC.

### <<Preparation of Polycarboxylic Acid-Based Dispersant Q2>>

314 g of water was introduced into a stirred reactor, nitrogen was introduced to create a nitrogen atmosphere in the synthesis system, and the contents were heated to 80° C. The following 3 solutions were simultaneously added dropwise over a 2-hour period into the synthesis system: a mixture of 61 g of water, 6.0 g of acrylic acid, 18.7 g of methacrylic acid, 169 g of methoxypolyethylene glycol monomethacrylate (MPEGM; molecular weight: approximately 2000), and 169 g of methoxypolyethylene glycol monoacrylate (MPEGA; molecular weight: approximately 1000); 78.4 g of 5% ammonium thioglycolate aqueous solution; and 78.4 g of 5% ammonium persulfate aqueous solution.

After the solutions had been added, 42.7 g of polyamide polyamine EO adduct obtained in the same manner as in the preparation of the polycarboxylic acid-based dispersant Q1 above was added dropwise over a 30-minute period, and 39.2 g of a 5% ammonium persulfate aqueous solution was added dropwise over a 1-hour period. Expressed as the mass ratio of solids, the proportions were: polyamide polyamine EO adduct: 6% by mass; acids (total of acrylic acid and methacrylic acid): 8% by mass; MPEGM: 43% by mass; and MPEGA: 43% by mass (total of 100% by mass). The contents were then aged over a 2-hour period, cooled, and neutralized to a pH of 6 using 48% NaOH aqueous solution, giving 1,000 g of polycarboxylic acid-based dispersant Q2. The weight-average molecular weight Mw of the polycarboxylic acid-based dispersant Q2 was 42,000, as determined by GPC.

### <<Admixture Preparation 1>>

Admixtures having the compositions shown in Table 2 below were prepared using the dispersants obtained as noted above (phenolic resin-based dispersant B1 and polycarboxylic acid-based dispersants Q1 and Q2).

TABLE 2

| | Phenolic resin- | Phenolic resin- | | | | | |
|---|---|---|---|---|---|---|---|
| | based dispersant | based dispersant | | | | | |
| | A1 (proportion | B1 (proportion | Polycarboxylic | Polycarboxylic | | | |
| | of x = 3 to 5: | of x = 3 to 5: | acid-based | acid-based | Sodium | | |
| | 0 mol %) | 20 mol %) | dispersant Q1 | dispersant Q2 | gluconate | Water | Total |
| Admixture Q | — | — | 14% | 3% | 4% | 79% | 100% |
| Admixture B1-1 | — | 21% | 6% | — | 3% | 70% | 100% |

### <<Preparation of Concrete Compositions, and Assessment 1>>

Concrete compositions were produced per JIS A 1138 using the formulations shown in Table 3. Table 3 shows that the ratio of blast furnace slag fine powder to the total of cement (C) and blast furnace slag fine powder (BS) (C/(C+BS)) was 75% (=354/(118+354)). The material was kneaded using a twin-screw forced mixing mixer (nominal capacity of 100 litres), and the amount of concrete produced for each batch was 50 litres per batch.

TABLE 3

| | Content (kg/m3) | | | | | | | | | | |
|---|---|---|---|---|---|---|---|---|---|---|---|
| | | Blast | Fine | | | | | | | | |
| | | furnace | aggregate | Fine | | | | | Water- | Sand- | |
| | | slag fine | (mountain | aggregate | Coarse | Water | | | binder | aggregate | AE |
| | Cement | powder | sand (S1)) | (fine sand | aggregate | (W) | Admixture | Admixture | ratio | ratio | agent |
| | (C)*1 | (BS)*2 | *3 | (S2)) *4 | (G)*5 | *6 | Q (%) | B1-1 (%) | (W/B) (%) | (s/a) (%) | (%) |
| Concrete | 118 | 354 | 510 | 221 | 936 | 170 | 0.95 | — | 36 | 44.6 | 0.009 |
| composition Q | | | | | | | | | | | |
| Concrete | 118 | 354 | 510 | 221 | 936 | 170 | — | 0.95 | 36 | 44.6 | 0.0075 |
| composition B1-1 | | | | | | | | | | | |

*1Ordinary portland cement (by Taiheiyo Cement Corporation; density: 3.16 g/cm3)
*2Cement A (by DC Co., Ltd.; density: 2.89 g/cm3)
*3 Mountain sand (from Kimitsu, Chiba Prefecture; density: 2.6 g/cm3; FM: 2.14)
*4 Fine sand (from Sakuragawa; density: 2.6 g/cm3, FM: 3.03)
*5Crushed limestone (from Hachinohe City, Aomori Prefecture; density: 2.7 g/cm3)
*6 Tap water (density: 1.00 g/cm3)

The concrete compositions that had been prepared were assessed over a period of 5 minutes to 90 minutes after being produced. The compositions were assessed as follows.

### <Slump and Slump-Flow>

The concrete compositions were assessed for slump and slump-flow per JIS A 1101:2020 and JIS A 1150:2020, respectively.

### <Air Content>

Concrete compositions were assessed for air content per JIS A 1128:2019.

### <O Funnel Flow Time and V Funnel Flow Time>

The air content of the concrete compositions was assessed on the basis of O funnel flow time and V funnel flow time per the “Test of High-Flow Concrete Fluidity Using Funnel (draft): JSCE F-512.”

### <Setting Time>

The setting time of the concrete compositions was determined per JIS A 1147.

### <Compressive Strength>

Compressive strength test pieces were prepared per JIS A 1132, and the crushing strength was measured per JIS A 1108.

Table 4 shows the results of the assessments for the concrete compositions of each formulation.

TABLE 4

| | | | | | | | | | | Compressive | |
|---|---|---|---|---|---|---|---|---|---|---|---|
| | | | Slump- | Air | O funnel | V funnel | Concrete | | | strength | |
| | Time | Slump | flow | content | flow time | flow time | temperature | Setting time | | (N/mm2) | |
| | (minutes) | (cm) | (cm) | (%) | (seconds) | (seconds) | (° C.) | Start | End | 7 days | 28 days |
| Concrete | 5 | 23.0 | 45.0 | 4.7 | 7.0 | 8.1 | 16.9 | 9 h 08 m | 13 h 24 m | 45.7 | 59.8 |
| composition | 30 | 23.5 | 45.5 | 4.0 | — | — | 16.8 | | | | |
| Q | 60 | 23.0 | 40.0 | 3.5 | 8.3 | 10.6 | 16.9 | | | | |
| | 90 | 20.0 | 32.5 | 3.5 | — | — | 16.7 | | | | |
| Concrete | 5 | 22.5 | 39.5 | 3.5 | 11.2 | 13.9 | 17.1 | 8 h 08 m | 12 h 16 m | 43.6 | 56.8 |
| composition | 30 | 22.0 | 37.5 | 3.5 | — | — | 16.8 | | | | |
| B1-1 | 60 | 21.0 | 34.0 | 3.2 | 13.6 | 21.0 | 16.7 | | | | |
| | 90 | 17.0 | 28.0 | 3.2 | — | — | 16.8 | | | | |

Table 4 shows that the concrete composition B1-1 that was obtained using the phenolic resin-based dispersant B1 of the present invention had more stable properties over time and maintained a more suitable amount of air compared with concrete composition A that was obtained using polycarboxylic acid-based dispersants Q1 and Q2.

### <<Admixture Preparation 2>>

Admixtures having the compositions shown in Table 5 below were prepared using the dispersants obtained as noted above (phenolic resin-based dispersants A1 and B1, as well as polycarboxylic acid-based dispersants Q1 and Q2).

TABLE 5

| | Phenolic resin- | Phenolic resin- | | | | | |
|---|---|---|---|---|---|---|---|
| | based dispersant | based dispersant | | | | | |
| | A1 (proportion | B1 (proportion | Polycarboxylic | Polycarboxylic | | | |
| | of x = 3 to 5: | of x = 3 to 5: | acid-based | acid-based | Sodium | | |
| | 0 mol %) | 20 mol %) | dispersant Q1 | dispersant Q2 | gluconate | Water | Total |
| Admixture A | 30% | — | — | — | — | 70% | 100% |
| Admixture B1-2 | — | 30% | — | — | — | 70% | 100% |

### <<Preparation of Concrete, and Assessment 2>>

Concrete compositions were produced per JIS A 1138 using the formulations shown in Table 6. Table 6 shows that the ratio of blast furnace slag fine powder to the total of cement (C) and blast furnace slag fine powder (BS) (C/(C+BS)) was 65% (=307/(165+307)). The material was kneaded using a twin-screw forced mixing mixer (nominal capacity of 100 litres), and the amount of concrete produced for each batch was 50 litres per batch.

TABLE 6

| | Content (kg/m3) | | | | | |
|---|---|---|---|---|---|---|
| | | Blast furnace | Fine aggregate | Fine aggregate | Coarse | |
| | Cement | slag fine | (mountain sand | (fine sand | aggregate | Water |
| | (C)*1 | powder (BS) *2 | (S1)) *3 | (S2)) *4 | (G)*5 | (W) *6 |
| Concrete composition A1 | 165 | 307 | 387 | 379 | 0.009 | 170 |
| Concrete composition B1-2 | 165 | 307 | 387 | 379 | 0.0075 | 170 |

| | | | | | Water- | |
|---|---|---|---|---|---|---|
| | | | | | binder | |
| | | | | | ratio | Sand- |
| | | | | AE | (W/B) (%) | aggregate |
| | Admixture | Admixture | Antifoamer | agent | (B = C + | ratio |
| | A1 (%) | B1-2 (%) | (%) | (%) | BS) | (s/a) (%) |
| Concrete composition A1 | 1.15 | — | 0.002 | 0.009 | 36 | 44.6 |
| Concrete composition B1-2 | — | 0.6 | 0.002 | 0.0075 | 36 | 44.6 |

*1Ordinary portland cement (by Taiheiyo Cement Corporation; density: 3.16 g/cm3)
*2 Cement A (by DC Co., Ltd.; density: 2.89 g/cm3)
*3 Mountain sand (from Kimitsu, Chiba Prefecture; density: 2.6 g/cm3; FM: 2.14)
*4 Fine sand (from Sakuragawa; density: 2.6 g/cm3, FM: 3.03)
*5Crushed limestone (from Hachinohe City, Aomori Prefecture; density: 2.7 g/cm3)
*6 Tap water (density: 1.00 g/cm3)

The concrete compositions that had been prepared were assessed as shown below.

### <Slump and Slump-Flow>

The concrete compositions were assessed for slump and slump-flow per JIS A 1101:2020 and JIS A 1150:2020, respectively.

### <Air Content>

Concrete compositions were assessed for air content per JIS A 1128.

### <O Funnel Flow Time and V Funnel Flow Time>

The air content of the concrete compositions was assessed on the basis of O funnel flow time and V funnel flow time per the “Test of High-Flow Concrete Fluidity Using Funnel (draft): JSCE F-512.”

### <Organoleptic Assessment of Handling>

A scoop was used to organoleptically assess the softness of the concrete compositions.
5: Very soft
4: Soft
3: Somewhat soft
2: Hard
1: Very hard

Table 7 shows the results of the assessments for the concrete compositions of each formulation.

TABLE 7

| | | | | | Organoleptic | | |
|---|---|---|---|---|---|---|---|
| | | | | Air | test of | Concrete | V funnel |
| | Time | Slump | Slump-flow | content | handling | temperature | flow time |
| | (minutes) | (cm) | (cm) | (%) | (score) | (° C.) | (seconds) |
| Concrete | 0 | 22 | 37.5 | 1.4 | 3 | 19 | 15.5 |
| composition | 30 | 8.5 | 21.5 | 1.9 | 1 | 19 | — |
| A1 | 60 | (Not measurable) | (Not measurable) | (Not measurable) | 0.5 | (Not measurable) | — |
| Concrete | 0 | 23 | 40.5 | 2.9 | 4-5 | 19 | 10.3 |
| composition | 30 | 21 | 35.0 | 2.8 | 3 | 19 | — |
| B1-2 | 60 | 19 | 30.0 | 2.8 | 3 | 19 | — |

Table 6 shows that the concrete composition B1-2 that was obtained using the phenolic resin-based dispersant B1 of the present invention had more stable properties over time and maintained a more suitable amount of air compared with concrete composition A that was obtained using the phenolic resin-based dispersant A.

Polyethylene glycol groups (CₓH₂ₓ groups, where x=2) were added using ethylene oxide (EO) as the alkylene oxide (AO) to synthesize the monomers for the phenolic resin-based dispersant A1, whereas a mixture of alkylene oxides was added as the alkylene oxide (AO) to synthesize the monomers for the phenolic resin-based dispersant B1. The ratio of CₓH₂ₓ groups in which x was 3 to 5 (X=3 to 5 (mol %)) relative to the total of CₓH₂ₓ groups in which x was 2 to 5 was 0 mol % in phenolic resin-based dispersant A1 but was 20 mol % in phenolic resin-based dispersant B1.

1. A method for improving the workability of an inorganic binder composition that contains a slag-containing inorganic binder, comprising the following steps (a) to (c):
(a) providing a dispersant;
(b) providing the inorganic binder composition; and
(c) intermilling and/or intermixing the dispersant provided in step (a) and the inorganic binder composition provided in step (b),
wherein the dispersant is a phenolic resin-based dispersant that is obtained via polycondensation of the following monomers (i) to (v):
(i) a mol % of a monomer represented by formula (I): 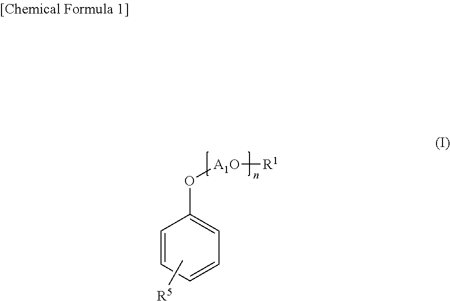
(ii) b mol % of a monomer represented by formula (II): 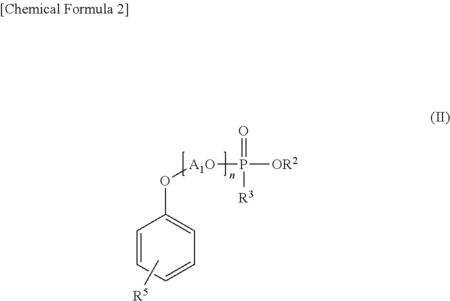
(iii) c mol % of a monomer represented by formula (III): 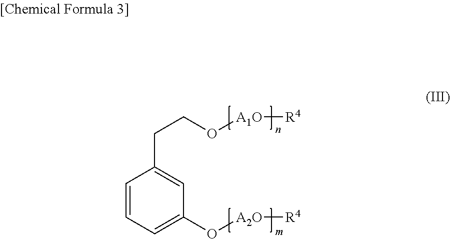
(iv) d mol % of a monomer represented by formula (IV): 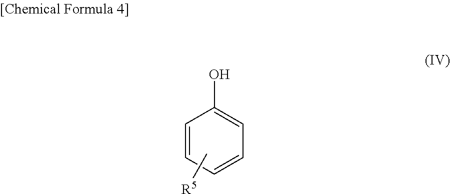
(v) e mol % of an aldehyde,
where
R¹ is H or a C₁₋₄ alkyl group or a C₂₋₅ acyl group,
R² is H, an alkali metal ion, an alkaline earth metal ion, or a moiety having the following structure: 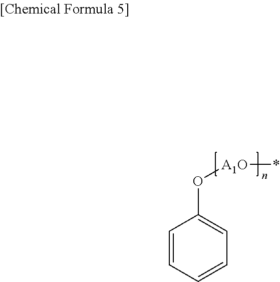
R³ is H or O—R²,
R⁴ is H, a C₁₋₄ alkyl group, or a phosphoric acid ester group,
R⁵ is H, a C₁₋₁₈ alkyl group, polyisobutene, or a sulfonic acid moiety,
A₁ and A₂ are each independently a CₓH₂ₓ group, where x=2 to 5,
n=1 to 350, m=2 to 300,
the a:b:c:d molar ratio is 0.1 to 2.0:0.1 to 6.0:0.1 to 2.0:0.0 to 0.5, and
the (a+b+c+d):e molar ratio is 1:10 to 10:1.

2. The method according to claim 1, wherein the slag content is at least 70% by mass, relative to the total dry mass of the inorganic binder.

3. The method according to claim 1, wherein the slag is steel slag.

4. The method according to claim 1, wherein the phenolic resin-based dispersant is intermilled and/or intermixed in an amount of 0.1 to 5% by mass, relative to the total dry mass of the inorganic binder in step (c).

5. The method according to claim 1, wherein the dispersant is intermilled with the inorganic binder composition in a ball mill or a vertical roll mill in step (c).

6. The method according to claim 1, wherein the inorganic binder composition further comprises at least one polycarboxylic acid-based polymer and/or gluconate.

7. An inorganic binder composition, comprising the following:
(a) 280 to 550 kg/m³ of slag-containing inorganic binder;
(b) 700 to 950 kg/m³ of fine aggregate,
(c) 800 to 1100 kg/m³ of coarse aggregate, and
(d) 0.1 to 5% by mass, of a dispersant, relative to the total dry mass of the inorganic binder;
the inorganic binder composition wherein the dispersant is a phenolic resin-based dispersant that is obtained via polycondensation of the following monomers (i) to (v):
(i) a mol % of a monomer represented by formula (I): 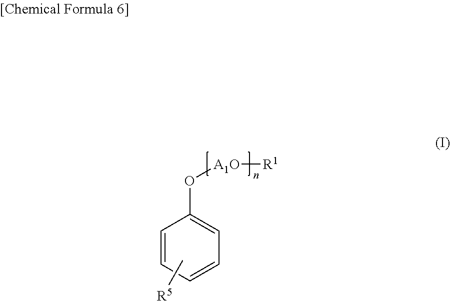
(ii) b mol % of a monomer represented by formula (II): 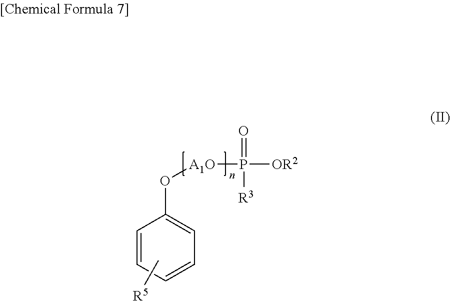
(iii) c mol % of a monomer represented by formula (III): 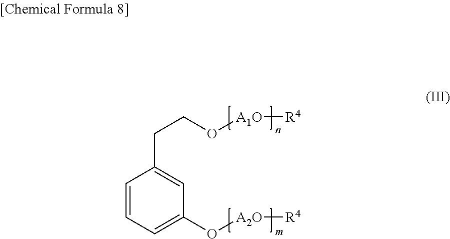
(iv) d mol % of a monomer represented by formula (IV): 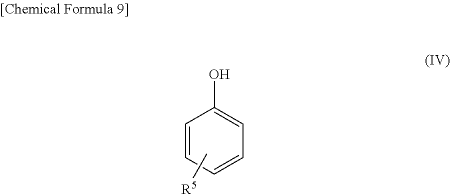
(v) e mol % of an aldehyde,
where
R¹ is H or a C₁₋₄ alkyl group or a C₂₋₅ acyl group,
R² is H, an alkali metal ion, an alkaline earth metal ion, or a moiety having the following structure: 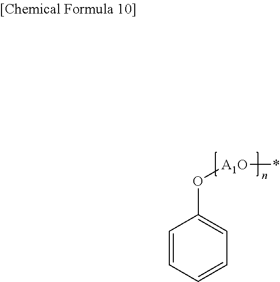
R³ is H or O—R²,
R⁴ is H, a C₁₋₄ alkyl group, or a phosphoric acid ester group,
R⁵ is H, a C₁₋₁₈ alkyl group, polyisobutene, or a sulfonic acid moiety,
A₁ and A₂ are each independently a CₓH₂ₓ group, where x=2 to 5,
n=1 to 350, m=2 to 300,
the a:b:c:d molar ratio is 0.1 to 2.0:0.1 to 6.0:0.1 to 2.0:0.0 to 0.5, and
the (a+b+c+d):e molar ratio is 1:10 to 10:1.

8. The inorganic binder composition according to claim 7, wherein the inorganic binder is substantially composed of cement and slag.

9. The inorganic binder composition according to claim 7, wherein said inorganic binder composition furthermore comprises fly ash and/or fine calcium carbonate in addition to the cement and slag.

10. The inorganic binder composition according to claim 8, wherein the slag-to-cement mass ratio is 2.3:1 to 6:1.

11. The inorganic binder composition according to claim 7, wherein the slag is steel slag.

12. The inorganic binder composition according to claim 7, wherein the V funnel flow time per JSCE-F 512:1999 is no more than 10 seconds, as determined 5 minutes after being mixed with water at a water-to-inorganic binder mass ratio of 0.25 to 0.6.

13. The inorganic binder composition according to claim 7, further comprising at least one polycarboxylic acid-based polymer and/or gluconate.

14. A moulded article, obtained by mixing the inorganic binder composition according to claim 7 with water in a water-to-inorganic binder mass ratio of 0.25 to 0.6, and then curing the resulting mixture.
